(19) United States
(12) Patent Application Publication
(10) Pub. No.: US 2010/0160562 A1
(43) Pub. Date: Jun. 24, 2010

(54) RELEASE AGENT AND RELEASE SHEET

(75) Inventors: Shiori BEPPU, Saitama (JP); Toshio Sugizaki, Kanagawa (JP)

Correspondence Address: Ditthavong Mori & Steiner, P.C., 918 Prince Street, Alexandria, VA, 22314, US

(73) Assignee: LINTEC Corporation, Tokyo (JP)

(21) Appl. No.: 12/620,596

(22) Filed: Nov. 18, 2009

(30) Foreign Application Priority Data
Dec. 18, 2008 (JP) 2008-322749

(51) Int. Cl. C08F 220/18; C08F 8/30; C08F 8/32; C08F 8/00

(52) U.S. Cl. 525/123; 525/329.7; 525/329.9; 525/330.2; 526/329.6

(57) ABSTRACT

According to the present invention, there is provided a release agent and a release sheet. The release sheet is composed of a base member and a release agent layer including the release agent. The release agent layer is provided on at least one surface of the base member. The release agent contains a poly(meth)acrylate that includes a mono or polyalkylene glycol (meth)acrylate unit having an alkyl or aryl end group (unit (A)), and an alkyl (meth)acrylate unit (unit (B)). The carbon number of the alkyl group in the unit (B) is from 1 to 30.

### BACKGROUND OF THE INVENTION

1. Field of the Invention

The present invention relates to a release agent including an alkylene glycol (meth) acrylate, and relates to a release sheet having a layer of the release agent.

2. Description of the Related Art

A release sheet is used for producing a ceramic green sheet that is utilized when multi-layer ceramic capacitors (MLCC) or the like are manufactured, and is used for producing an adhesive resin sheet that is utilized when flexible printed circuits (FPC) or the like are manufactured. In these usages, since a ceramic slurry or an adhesive resin is applied onto the release agent layer of the release sheet, the release agent needs to have high wettability for the ceramic slurry or the adhesive resin. Also, the release sheet needs to have a moderate release force, in these usages.

Conventionally, a silicone release agent or a non-silicone release agent such as a melamine resin, an alkyd resin, and an acryl release agent including a long-chain alkyl group and so on is used for the release agent of the release sheet, as shown in Japanese Unexamined Patent Publication (KOKAI) Nos. 63-202685 and 2003-147327. The silicone release agent has low wettability for the ceramic slurry and the adhesive resin because of its low surface tension, and therefore, cissing could occur when they are applied onto the release agent layer. In addition, the silicone contamination could induce an improper operation in an electronic device. Furthermore, because the release force of the silicone release agent is relatively low, while that of the release agent of an alkyd resin or a melamine resin is relatively high, these release agents are not appropriate for the above-mentioned usages.

On the other hand, an acryl release agent including a long-chain alkyl group is more appropriate for the above-mentioned usages, because the release force and the wettability can be controlled by modifying the type and the amount of monomer. The carbon number of the alkyl group needs to be large for the moderate release force. However, it causes the curability of the release agent to decrease by crystallization of the long-chain alkyl group.

### SUMMARY OF THE INVENTION

Therefore, an object of the present invention is to provide a release agent that prevents cissing when the ceramic slurry or the adhesive resin are applied onto the release agent layer while maintaining the good curability of the release agent, and that provides good release properties when the release sheet is released from the ceramic green sheet or the adhesive resin sheet that is produced by coating the ceramic slurry or the adhesive resin.

According to the present invention, there is provided a release agent comprising a poly(meth)acrylate, the poly(meth)acrylate comprising: a mono or polyalkylene glycol (meth)acrylate unit having an alkyl or aryl end group (unit (A)); and an alkyl (meth)acrylate unit, the carbon number of the alkyl group being from 1 to 30 (unit (B)).

According to another aspect of this invention, there is provided a release sheet comprising a base member and a release agent layer formed of the release agent, provided on at least one surface of the base member.

In this invention, the release agent or the release sheet are used in a process for producing a ceramic green sheet or an adhesive resin film, for example. Namely, according to yet another aspect of this invention, there is provided a method for producing a ceramic green sheet or an adhesive resin film. The method comprises preparing the release sheet and coating a ceramic slurry or an adhesive resin onto the release agent layer of the release sheet.

### DESCRIPTION OF THE PREFERRED EMBODIMENTS

The present invention will be described below with reference to embodiments.

A release agent in one embodiment of this invention comprises a poly(meth)acrylate copolymer as a base polymer. The poly(meth)acrylate copolymer includes a mono or polyalkylene glycol (meth)acrylate unit having an alkyl or aryl end group (unit (A)); and an alkyl (meth)acrylate unit, the carbon number of the alkyl group being from 1 to 30 (unit (B)).

The above-mentioned unit (A) is represented by the following formula (1), for example.

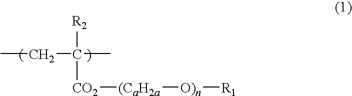

In formula (1), R₁ represents an alkyl or an aryl group, R₂ represents a hydrogen atom or a methyl group, “a” represents 2 or 3, and “n” represents an integer number from 1 to 100.

In formula (1), R₁ is preferably an alkyl group with the carbon number from 1 to 10, or an aryl group with the carbon number from 6 to 16, such as a phenyl group, an alkylphenyl group having the carbon number from 1 to 10 in the alkyl part, and so on. If the alkyl part in R₁ is relatively large, the flexibility of the unit (A) is low and the wettability of the coated surface of the release agent is not established sufficiently; therefore, it is better that the carbon number in the alkyl part in R₁ is smaller. Accordingly, in formula (1), R₁ is more preferably an alkyl group with the carbon number from 1 to 5, or an aryl group with the carbon number from 6 to 11, such as a phenyl group, an alkylphenyl group having the carbon number from 1 to 5 in the alkyl part, and so on. Most preferably, R₁, is a methyl or phenyl group.

The number of the repeating units of the alkylene glycols part, namely “n” in formula (1), is preferably from 1 to 20, and is more preferably from 2 to 10, since the polymerizability decreases and the handling quality of the monomer compound becomes lower if the number becomes larger. The mono or polyalkylene glycol part in the unit (A) includes an ethylene glycol part and/or a propylene glycol part. The polyalkylene glycol part might be formed by bonding an ethylene glycol and a propylene glycol randomly or alternatively, or might be formed by bonding a poly(ethylene glycol) block and a poly(propylene glycol) block. However, “a” in formula (1) is preferably 2, and the polyalkylene glycol part is preferably formed of consecutive ethylene glycols. The example of the unit (A) includes methoxy poly(ethylene glycol) acrylate, methoxy poly(ethylene glycol) methacrylate, phenoxy poly(ethylene glycol) acrylate, phenoxy poly(ethylene glycol) methacrylate, and so on.

The unit (B) is represented by the following formula (2), for example.

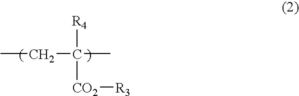

In formula (2), R₃ represents an alkyl group with the carbon number from 1 to 30, and R₄ represents a hydrogen atom or a methyl group.

Since the curability decreases if the carbon number in R₃ is relatively large, and it is difficult to achieve the good release properties of the release agent layer if it is relatively small, R₃ in formula (2) is preferably an alkyl group with the carbon number from 10 to 20, for example a linear alkyl group such as a lauryl group, a stearyl group, and so on. The example of the unit (B) includes lauryl acrylate, lauryl methacrylate, stearyl acrylate, stearyl methacrylate, and so on.

In the poly(meth)acrylate copolymer, which is the base polymer, the mass ratio of the unit (A)/(B) is from 100/1 to 100/200 for example, and is preferably from 100/10 to 100/100. The weight-average molecular weight of the poly(meth)acrylate copolymer (the base polymer), which is measured by Gel Permeation Chromatography (GPC), is not limited but might be from 1,000 to 1,000,000 for achieving good coatability of the release agent, and is preferably from 10,000 to 1,000,000.

Optionally, the poly(meth)acrylate copolymer, which is the base polymer in the release agent, may include a (meth) acrylate unit including a reactive functional group as well as the units (A) and (B). This unit would react and bond with the crosslinking agent as described below so as to improve the curability. The reactive functional group is a hydroxyl group, or a carboxyl group, for example. The (meth) acrylate unit including a reactive functional group is hydroxyethyl acrylate or acrylic acid, for example. The (meth)acrylate unit including a reactive functional group is included in the poly(meth)acrylate copolymer with mass ratio from 0.1% to 50% with respect to the base polymer, for example.

The poly(meth)acrylate copolymer, which is the base polymer, may optionally include a (meth)acrylate unit including fluorine as well as the units (A) and (B) for controlling the release properties of the release agent layer. The examples of the (meth)acrylate unit including fluorine include 2,2,2-trifluoroethylacrylate, 1,1,1,3,3,3-hexafluoro-2-propylacrylate, perfluoroethylmethylacrylate, 2-(perfluorooctyl)ethyl acrylate, and so on.

The poly(meth)acrylate copolymer is obtained by polymerizing such as radically polymerizing compounds (monomers) for the units (A) and (B) or compounds (monomers) for the units (A) and (B) as well as the optional (meth)acrylate unit as described above. The mixture of the compounds (monomers), which solvent, polymerization initiator and other additives may be added to, may be heated for the polymerization.

The release agent in this embodiment further comprises a crosslinking agent. The poly(meth)acrylate copolymer, which has been copolymerized, is cross-linked with the crosslinking agent. As the crosslinking agent, a melamine, an isocyanate, an epoxy, an aluminum chelate, a titanium chelate, an ultraviolet curing resin, a mixture of two or more of these or like, is utilized, for example. The mass ratio of the base polymer to the crosslinking agent is from 100/1 to 100/200, and is preferably from 100/10 to 100/100.

The release sheet in this embodiment comprises a base member and a release agent layer that is provided on one or both surfaces of the base member, and is formed of the release agent. In this embodiment, the crosslinking agent and if desired solvent, catalyst, and others are added to the poly(meth)acrylate copolymer, which has been copolymerized, and then the resultant mixture is applied as a coating onto the base member and then is dried and cured so that the release agent layer is formed. In the release sheet, the thickness of the release agent layer is about 0.01 to 10 μm.

The base member can be selected from a number of different conventional materials; for example a resin film that is composed of polyester such as polyethylene terephthalate and polyethylene naphthalate, polyolefin such as polypropylene, polyimide, or like is utilized. In the release sheet, other layer (s) may be provided between the base member and the release agent layer if desired. It is preferable that neither the release agent nor each element composing the release sheet (such as the release agent layer and the base member) include a silicone compound in order to prevent the silicone compound from contaminating the electronic device.

The release sheet is used in a process for producing a ceramic green sheet, which is utilized in a process for manufacturing a MLCC or like, for example. A ceramic slurry is applied as a coating onto the release agent layer of the release sheet and is dried so that the ceramic green sheet, which is provided on the release sheet, is produced.

Furthermore, the release sheet is used in a process for producing an adhesive resin film, which is utilized in a process for manufacturing an FPC or like, for example. Adhesive resin liquid such as an epoxy resin, a polyimide resin or the like is applied as a coating onto the release agent layer of the release sheet and is cured so that the adhesive resin film, which is provided on the release sheet, is produced. The release sheet is released from the ceramic green sheet or the adhesive resin film in the process of manufacturing the MLCC, the FPC or like.

In the release sheet, a contact angle of the surface of the release agent layer with pure water is not more than 108° and is preferably from 28° to 108°, in order to achieve sufficient wettability with the ceramic slurry or the adhesive resin liquid. Furthermore, the release force of the release sheet, which is measured by the method as described below, is preferably from 300 to 1000 mN/20 mm, and is more preferably from 500 to 800 mN/20 mm, in order to release the release sheet from the ceramic green sheet or the adhesive resin film in good condition.

In this embodiment, a part of the base polymer in the release agent is composed of alkyleneglycol having flexibility, which improves the curability of the release agent, because the crystallization of the alkyl group in the alkyl (meth) acrylate unit may be broken. In addition, the wettability of the coated surface of the release agent is improved because of its high surface tension, and accordingly, when the resin liquid or the ceramic slurry is coated onto the release agent layer, cissing and uneven coating are prevented.

Furthermore, the release force of the release sheet can be moderate because a part of the base polymer units of the release agent are composed of the alkyl (meth)acrylate unit. Accordingly, the release properties of the release sheet are suitable in processes for producing the ceramic green sheet and the adhesive resin sheet.

### EXAMPLES

Next, the present invention shall be explained in further detail with reference to examples, but the present invention shall not be restricted by these examples.

### Example 1

50 grams of methoxy tri(ethylene glycol) acrylate (brand name: V-MTG, manufactured by Osaka Organic Chemical Industry Ltd.) as monomer for the unit (A), 50 grams of lauryl acrylate as monomer for the unit (B), 0.359 grams of azobis isobutyronitrile (AIBN) as the polymerization initiator, and 200 grams of ethyl acetate as the solvent were added into a 1-liter flask that was provided with a stirrer, a lead-in tube for nitrogen, a thermometer, and a condenser. The polymerization reaction was then conducted under nitrogen stream at 70° C. for two hours so as to obtain copolymer I. The weight-average molecular weight by GPC of the copolymer I was 101,000.

10 grams of melamine resin (brand name: Cymel 303, manufactured by Nihon Cytec Industries Inc.) as the crosslinking agent and 0.5 grams of p-toluenesulfonic acid as the catalyst were added to 100 grams of the copolymer I and were diluted with a solvent mixture of toluene and methyl ethyl ketone (mass ratio 3:7) to prepare an application liquid with a solid concentration of 1% by mass. The application liquid was applied as a coating onto a polyethylene terephthalate (PET) film having a thickness of 38 μm by using a Meyer Bar, and then was dried at 145° C. for one minute to obtain a release sheet so that the thickness of the coated layer after drying was made to be 0.1 μm.

### Example 2

50 grams of methoxypoly(ethylene glycol) methacrylate having an ethylene glycols part of which the average number of the repeating units is 9 (brand name: PME-400, manufactured by NOF Corp.) as monomer for the unit (A), 50 grams of stearyl acrylate as monomer for the unit (B), 0.209 grams of azobis isobutyronitrile (AIBN) as the polymerization initiator, and 100 grams of ethyl acetate and 100 grams of toluene as the solvents were added into a 1-liter flask that was provided with a stirrer, a lead-in tube for nitrogen, a thermometer, and a condenser. The polymerization reaction was then conducted under nitrogen stream at 70° C. for 12 hours so as to obtain copolymer II. The weight-average molecular weight by GPC of the copolymer II was 50,000. A release sheet was obtained using the copolymer II by the same manner as that in Example 1.

### Example 3

45 grams of methoxy tri(ethylene glycol) acrylate, same as that used in Example 1, as monomer for the unit (A), 50 grams of lauryl acrylate as monomer for the unit (B), 5 grams of hydroxyethyl acrylate as monomer for the (meth)acrylate unit including a reactive functional group, 0.375 grams of azobis isobutyronitrile (AIBN) as the polymerization initiator, and 200 grams of ethyl acetate as the solvent were added into a 1-liter flask that was provided with a stirrer, a lead-in tube for nitrogen, a thermometer, and a condenser. The polymerization reaction was then conducted under nitrogen stream at 70° C. for two hours so as to obtain copolymer III. The weight-average molecular weight by GPC of the copolymer III was 95,000.

5 grams of TMP-HDI (brand name: Coronate HL, manufactured by Nippon Polyurethane Industry Co. Ltd.) as the crosslinking agent was added to 100 grams of the copolymer III and then diluted with a solvent mixture of toluene and methyl ethyl ketone (mass ratio 3:7) to prepare an application liquid with a solid concentration of 1% by mass. The application liquid was applied as a coating onto a polyethylene terephthalate (PET) film having a thickness of 38 μm by using a Meyer Bar, and then dried at 100° C. for one minute to obtain a release sheet so that the thickness of a coated layer after drying was made to be 0.1 μm.

### Example 4

50 grams of phenoxy poly(ethylene glycol) methacrylate having an ethylene glycols part of which the average number of the repeating units is 2 (brand name: PAE-100, manufactured by NOF Corp.) as monomer for the unit (A), 50 grams of lauryl acrylate as monomer for the unit (B), 0.335 grams of azobis isobutyronitrile (AIBN) as the polymerization initiator, and ethyl acetate 200 grams as the solvent were added into a 1-liter flask that was provided with a stirrer, a lead-in tube for nitrogen, a thermometer, and a condenser. The polymerization reaction was then conducted under nitrogen stream at 70° C. for two hours so as to obtain copolymer IV. The weight-average molecular weight by GPC of the copolymer IV was 85,000. A release sheet was obtained using the copolymer IV by the same manner as that in Example 1.

### Example 5

45 grams of methoxy tri(ethylene glycol) acrylate, same as that used in Example 1, as monomer for the unit (A), 50 grams of lauryl acrylate as monomer for the unit (B), 5 grams of 2-(perfluorooctyl)ethyl acrylate as monomer for the (meth) acrylate unit including fluorine, 0.348 grams of azobis isobutyronitrile (AIBN) as the polymerization initiator, and 200 grams of ethyl acetate as solvent were added into a 1-liter flask that was provided with a stirrer, a lead-in tube for nitrogen, a thermometer, and a condenser. The polymerization reaction was then conducted under nitrogen stream at 70° C. for two hours so as to obtain copolymer V. The weight-average molecular weight by GPC of the copolymer V was 92,000. A release sheet was obtained using the copolymer V by the same manner as that in Example 1.

### Comparative Example 1

100 grams of stearyl acrylate, 0.253 grams of azobis isobutyronitrile (AIBN) as the polymerization initiator, and 200 grams of toluene as solvent were added into a 1-liter flask that was provided with a stirrer, a lead-in tube for nitrogen, a thermometer, and a condenser. The polymerization reaction was then conducted under nitrogen stream at 70° C. for 12 hours so as to obtain copolymer VI. The weight-average molecular weight by GPC of the copolymer VI was 60,000. A release sheet was obtained using the copolymer VI by the same manner as that in Example 1.

### Comparative Example 2

50 grams of stearyl acrylate, 50 grams of methyl methacrylate, 1.072 grams of azobis isobutyronitrile (AIBN) as the polymerization initiator, and 100 grams of ethyl acetate and 100 grams of toluene as the solvents were added into a 1-liter flask that was provided with a stirrer, a lead-in tube for nitrogen, a thermometer, and a condenser. The polymerization reaction was then conducted under nitrogen stream at 70° C. for 12 hours so as to obtain copolymer VII. The weight-average molecular weight by GPC of the copolymer VII was 39,000. A release sheet was obtained using the copolymer VII by the same manner as that in Example 1.

### [Evaluations]

The release sheets were evaluated according to the tests as described below.

### (1) Release Force

A polyester adhesive tape (brand name: No. 31B, manufactured by Nitta Denko Corp.) was adhered onto a surface of the release sheet where the release agent layer had been provided by pressing with a two-kilogram roller in one reciprocation, and then was left to stand for 30 minutes at 23° C. under 50% R. H. The release sheet to which the adhesive tape had been adhered was cut into a piece having a width of 20 mm and a length of 150 mm, and then the release force was measured by peeling the adhesive tape away from the piece of release sheet at a peeling angle of 180° and a peeling rate of 0.3 mm/min, at 23° C. under 50% R.H.

### (2) Curability

The surface of the release sheet where the release agent layer had been provided was rubbed 10 times with fingers, and then the presence of smear was confirmed by visual observation. Next the polyester adhesive tape as described above was adhered to the rubbed part of the release sheet, and then the release force was measured in the manner described above. The presence of rub-off (whether the coated layer was partially removed) was confirmed by a change in the release force before and after rubbing. The rub-off was evaluated based on the evaluation criterion as described below.

### [Evaluation Criterion for Smear]

∘: Smear was either not present at all or only slightly present but not enough to cause a practical problem.

x: Enough of a slight smear was present that it could cause a practical problem.

xx: Smear was significantly present.

### [Evaluation Criterion for Rub-Off]

∘: Rub-off was either not present at all or only slightly present but not enough to cause a practical problem.

x: enough of a slight rub-off was present that it could cause a practical problem.

xx: Rub-off was significantly present.

### (3) Wettability

The contact angle of the surface of the release sheet where the release agent layer had been provided, with pure water, was measured by a drop method using a contact angle meter (type: CA-X, manufactured by Kyowa Interface Science Co., Ltd.) at 23° C. under 50% R.H., in order to evaluate the wettablility of the surface of the release agent layer.

### (4) Coatability

A blend of 100 parts by mass of barium titanate (BaTiO₃) powder, 8 parts by mass of polyvinyl butyral, and 4 parts by mass of dioctyl phthalate, to which 80 parts by mass of a mixture of toluene and ethanol (mass retio: 1:1) were added, was mixed and dispersed by a ball mill to prepare ceramic slurry. The ceramic slurry was uniformly coated onto the surface of the release sheet by a doctor blade method where the release agent layer had been provided so that the thickness of a coated layer after drying was made to be 5 μm and then was dried to obtain a ceramic green sheet. The coated surface on the ceramic green sheet was visually observed and whether pinhole and orange peel were generated from cissing was evaluated based on the evaluation criterion as described below.

∘: None or very little Pinhole and orange peel were generated.

x: A little Pinhole and orange peel were generated.

xx: Substantial Pinhole and orange peel were generated.

TABLE 1

| | | | Contact | | Release |
|---|---|---|---|---|---|
| | Curability | | Angle | | Force |
| | Smear | Rub-off | [°] | Coatability | [mN/20 mm] |
| Ex. 1 | ∘ | ∘ | 31 | ∘ | 645 |
| Ex. 2 | ∘ | ∘ | 105 | ∘ | 583 |
| Ex. 3 | ∘ | ∘ | 30 | ∘ | 600 |
| Ex. 4 | ∘ | ∘ | 30 | ∘ | 750 |
| Ex. 5 | ∘ | ∘ | 33 | ∘ | 590 |
| Comp. 1 | xx | xx | 110 | x | 220 |
| Comp. 2 | ∘ | ∘ | 49 | ∘ | 2500 |

As described above, in Examples 1-5, because of the base polymer containing alkyleneglycol, the curability of the release agent and the coatability of the slurry onto the release agent layer improved while the release properties were appropriately maintained. Contrastingly, in Comparative Example 1, because alkylene glycol was not used, the curability of the release agent and the coatability of the slurry did not improve. In addition, in Comparative Example 2, the curability of the release agent and the coatability of the slurry could improve, but the release force was so high that the release properties were not suitable for the processes used in producing the ceramic green sheet and the adhesive resin film.

Although the embodiments of the present invention have been described herein, obviously many modifications and changes can be made by those skilled in this art without departing from the scope of the invention.

The present disclosure relates to subject matter contained in Japanese Patent Application No. 2008-322749 (filed on Dec. 18, 2008) which is expressly incorporated herein, by reference, in its entirety.

1. A release agent comprising a poly(meth)acrylate, said poly(meth)acrylate comprising:
(A) a mono or polyalkylene glycol (meth)acrylate unit having an alkyl or aryl end group; and
(B) an alkyl (meth)acrylate unit, the carbon number of the alkyl group being from 1 to 30.

2. A release agent according to claim 1, wherein the unit (A) is represented by the following formula (1) . 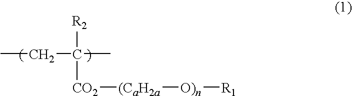
In formula (1), R₁ represents an alkyl or an aryl group, R₂ represents a hydrogen atom or a methyl group, “a” represents 2 or 3, and “n” represents an integer number from 1 to 100.

3. A release agent according to claim 1, wherein the unit (B) is represented by the following formula (2). 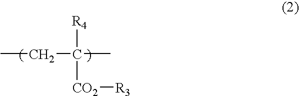
In formula (2), R₃ represents an alkyl group with the carbon number from 1 to 30, and R₄ represents a hydrogen atom or a methyl group.

4. A release agent according to claim 1, wherein the mass ratio of the unit (A)/(B) is from 100/1 to 100/200.

5. A release agent according to claim 1, wherein said poly(meth)acrylate comprises at least one (meth)acrylate unit which is selected from the group consisting of a (meth)acrylate unit including a reactive functional group and a (meth)acrylate unit including fluorine.

6. A release agent according to claim 5, wherein said reactive functional group is a hydroxyl group or a carboxyl group.

7. A release agent according to claim 1, wherein said poly(meth)acrylate, which is a base polymer, is cross-linked with at least one crosslinking agent selected from the group consisting of melamine, isocyanate, epoxy, aluminum chelate, titanium chelate, and ultraviolet curing resin.

8. A release agent according to claim 7, wherein the mass ratio of said base polymer to said crosslinking agent is from 100/1 to 100/200.

9. A release agent according to claim 1, wherein said release agent is used in a process for producing a ceramic green sheet or an adhesive resin film.

10. A release agent according to claim 1, wherein said release agent includes no silicone compound.

11. A release sheet comprising a base member, and a release agent layer formed of a release agent, provided on at least one surface of said base member, said release agent comprising a poly(meth)acrylate, said poly(meth)acrylate comprising:
(A) a mono or polyalkylene glycol (meth)acrylate unit having an alkyl or aryl end group; and
(B) an alkyl (meth)acrylate unit, the carbon number of the alkyl group being from 1 to 30.

12. A method for producing a ceramic green sheet, comprising:
preparing a release sheet comprising a base member, and a release agent layer formed of a release agent, provided on at least one surface of said base member; and
coating a ceramic slurry onto said release agent layer,
said release agent comprising a poly(meth)acrylate, said poly(meth)acrylate including (A) a mono or polyalkylene glycol (meth)acrylate unit having an alkyl or aryl end group; and (B) an alkyl (meth)acrylate unit, the carbon number of the alkyl group being from 1 to 30.

13. A method for producing an adhesive resin film, comprising:
preparing a release sheet comprising a base member, and a release agent layer formed of a release agent, provided on at least one surface of said base member; and
coating an adhesive resin onto said release agent layer,
said release agent comprising a poly(meth)acrylate, said poly(meth)acrylate including (A) a mono or polyalkylene glycol (meth)acrylate unit having an alkyl or aryl end group; and (B) an alkyl (meth)acrylate unit, the carbon number of the alkyl group being from 1 to 30.
